(19) United States
(12) Patent Application Publication
(10) Pub. No.: US 2006/0091777 A1
(43) Pub. Date: May 4, 2006

(54) Cathode ray tube

(75) Inventor: Sung Han Jung, Kumi-Si (KR)

Correspondence Address: BIRCH STEWART KOLASCH & BIRCH, PO BOX 747, FALLS CHURCH, VA, 22040-0747, US

(73) Assignee: LG Philips Displays Korea Co., LTD., Kumi-Si (KR)

(21) Appl. No.: 11/260,120

(22) Filed: Oct. 28, 2005

(30) Foreign Application Priority Data
Nov. 3, 2004 (KR) 10-2004-0088973

(51) Int. Cl. H01J 29/86; H01J 29/88; H01J 29/92; H01J 29/87; H01J 5/24

(52) U.S. Cl. 313/477 R; 313/479; 220/2.1 R; 220/2.1 A; 220/2.3 A

(57) ABSTRACT

A frame for a cathode ray tube including a panel formed with a blend region outside an effective screen of the panel, the blend region having an outer surface curvature having a radius satisfying a condition “20≦Rb≦60 (mm)” where “Rb” represents the outer surface curvature radius, so that it is possible to reduce the weight of the panel without causing a degradation in picture quality, and thus, to reduce manufacturing costs. It is also possible to reduce damage of the panel when the panel is processed in a furnace, and thus, to achieve an enhancement in productivity.

### BACKGROUND OF THE INVENTION

1. Field of the Invention

The present invention relates to a cathode ray tube, and, more particularly, to a cathode ray tube which includes a panel having a blend region formed outside an effective screen of the panel to have a radius of outer surface curvature within a predetermined range, thereby being capable of reducing the weight of the panel, and thus, reducing the manufacturing costs.

2. Description of the Related Art

FIG. 1 is a sectional view illustrating an inner configuration of a conventional cathode ray tube. As shown in FIG. 1, the conventional cathode ray tube includes a panel 1 having an inner surface, on which a phosphor material is coated, a funnel 2 coupled to the panel 2 to form a hollow vacuum body, an electron gun (not shown) arranged in the hollow vacuum body to emit an electron beam 5, and a deflection yoke 4 adapted to vertically and horizontally deflect the electron beam 5. The cathode ray tube also includes a shadow mask 3 provided with a plurality of slots to perform a color selecting function for the electron beam 5 deflected by the deflection yoke 4, and a mask frame 6 connected to the shadow mask 3 to support the shadow mask 3.

In the conventional cathode ray tube having the above-mentioned configuration, the electron beam 5 strikes a phosphor coated on the inner surface of the panel 1, thereby causing the phosphor to emit light by virtue of the energy of the electron beam 5. Thus, an image is reproduced.

Recently, research has actively been made to enhance the price competitiveness of cathode ray tubes through a reduction in prime cost. In order to secure the price competitiveness of a cathode ray tube, the elements of the cathode ray tube may have structures modified from those of conventional cases while exhibiting performance similar to those of the conventional cases, or may be manufactured using inexpensive materials.

In particular, in the above-mentioned cathode ray tube, the material costs of the panel 1 reaches about 40% of the total material costs of the cathode ray tube. For this reason, the manufacturing costs of the panel 1 must be taken into primary consideration in designing the cathode ray tube.

In order to reduce the manufacturing costs of the panel 1, a method of reducing the weight of the panel 1 may be used. However, when the effective screen portion of the panel 1 is reduced in weight, there are not only a degradation in picture quality, but also a degradation in anti-implosion characteristics caused by compressive stress generated due to vacuum established in the interior of the cathode ray tube.

Furthermore, when electron beams strike the panel 1, X-rays are externally discharged through the panel 1. For this reason, there is a limitation in reducing the thickness of the panel 1, in order to satisfy a required upper limit of the discharge amount of X-rays.

Although the portion of the panel 1 arranged outside the effective screen may have an improved structure to reduce the weight of the panel 1, there is another problem associated with the shape conformity of the panel 1 to a cabinet. As a result, there is still a limitation in reducing the weight of the panel 1.

### SUMMARY OF THE INVENTION

Therefore, the present invention has been made in view of the above-mentioned problems incurred in the related art, and it is an object of the invention to provide a cathode ray tube which includes a panel having a blend region formed outside an effective screen of the panel to have a radius of outer surface curvature within a predetermined range, thereby being capable of reducing the weight of the panel, and thus, reducing the manufacturing costs.

Another object of the invention is to provide a cathode ray tube which includes a panel having a reduced weight without causing a degradation in the apparent flatness perceived by the viewer when the viewer views the screen of the panel, thereby being capable of achieving a reduction in manufacturing costs.

In accordance with one aspect, the present invention provides a cathode ray tube comprising a panel having a predetermined curvature, a funnel coupled to a rear end of the panel, an electron gun adapted to emit an electron beam, a deflection yoke adapted to vertically and horizontally deflect the electron beam, and a shadow mask provided with a plurality of slots to perform a color selecting function for the electron beam, wherein the panel is formed with a blend region outside an effective screen of the panel, and the blend region has an outer surface curvature having a radius satisfying a condition “20≦Rb≦60 (mm)” where “Rb” represents the outer surface curvature radius. In accordance with another aspect, the present invention provides a cathode ray tube comprising a panel having a predetermined curvature, a funnel coupled to a rear end of the panel, an electron gun adapted to emit an electron beam, a deflection yoke adapted to vertically and horizontally deflect the electron beam, and a shadow mask provided with a plurality of slots to perform a color selecting function for the electron beam, wherein the panel is formed with a blend region outside an effective screen of the panel, and satisfies a condition

$$“ 1.5 \leq \frac{Tf}{Tc} 2.0 ”$$

where “Tf” represents a thickness of a thickest portion in the blend region, and “Tc” represents a thickness of a central portion of the panel.

In accordance with another aspect, the present invention provides a cathode ray tube comprising a panel having a predetermined curvature, a funnel coupled to a rear end of the panel, an electron gun adapted to emit an electron beam, a deflection yoke adapted to vertically and horizontally deflect the electron beam, and a shadow mask provided with a plurality of slots to perform a color selecting function for the electron beam, wherein the panel is formed with a blend region outside an effective screen of the panel, and the blend region has an outer surface curvature having a center arranged outside the panel.

The panel may satisfy a condition

$$“ 0.18 \leq \frac{OAH}{\frac{1}{2} USD} \leq 0.29 ”$$

where “USD” represents a diagonal length of the effective screen of the panel, and “OAH” represents a vertical length from a center of an inner surface of the panel to a seal edge of the panel.

The panel may have an outer surface curvature satisfying a condition “5,000 (mm)≦Rx, Ry, Rd≦30,000 (mm)” where “Rx” represents a radius of outer surface curvature of the panel along a longer axis of the panel, “Ry” represents a radius of outer surface curvature of the panel along a shorter axis of the panel, and “Rd” represents a radius of outer surface curvature of the panel along a diagonal axis of the panel.

The panel may have an outer surface curvature satisfying a condition

$$“ 0.5 \leq \frac{Rx + Ry}{2 \times Rd} \leq 0.9 ” .$$

### BRIEF DESCRIPTION OF THE DRAWINGS

The above objects, and other features and advantages of the present invention will become more apparent after reading the following detailed description when taken in conjunction with the drawings, in which:

FIG. 1 is a sectional view illustrating an inner configuration of a conventional cathode ray tube;

FIG. 2 is a sectional view of a panel included in a cathode ray tube according to the present invention, illustrating a radius of outer surface curvature at a blend region of the panel;

FIG. 3 is a sectional view of the panel included in the cathode ray tube according to the present invention, illustrating the thickness of the panel;

FIG. 4 is a schematic view illustrating the outer surface curvature of the panel in the cathode ray tube according to the present invention;

FIG. 5 is a sectional view illustrating the shape of the panel in the cathode ray tube according to the present invention, as compared to the shape of a conventional panel;

FIG. 6 is a perspective view illustrating the shape of the panel in the cathode ray tube according to the present invention;

FIG. 7 is a graph depicting the thickness characteristics of the panel in the cathode ray tube according to the present invention where the panel has an aspect ratio of 4:3;

FIG. 8 is a graph depicting the thickness characteristics of the panel in the cathode ray tube according to the present invention where the panel has an aspect ratio of 16:9; and

FIG. 9 is a graph depicting the thickness characteristics of the panel in the cathode ray tube according to the present invention where the panel has an aspect ratio of 4:3, and a shadow mask made of an aluminum killed (AK) material is used.

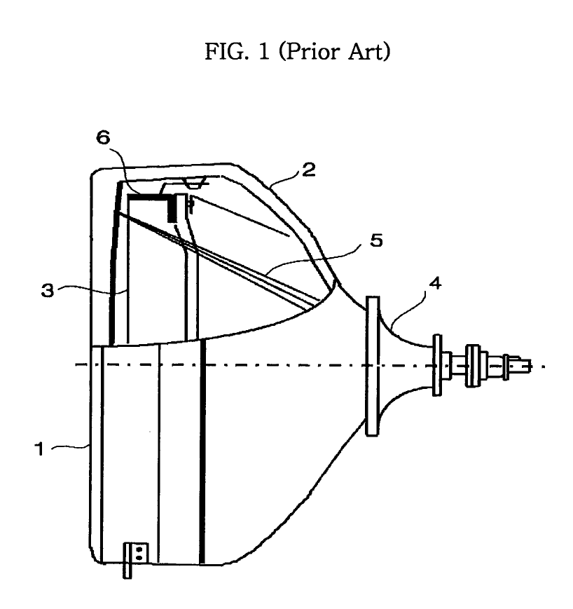

### DESCRIPTION OF THE PREFERRED EMBODIMENTS

Hereinafter, exemplary embodiments of a cathode ray tube according to the present invention will be described with reference to the annexed drawings. In the following description, the same elements are referred to by the same title and designated by the same reference numeral.

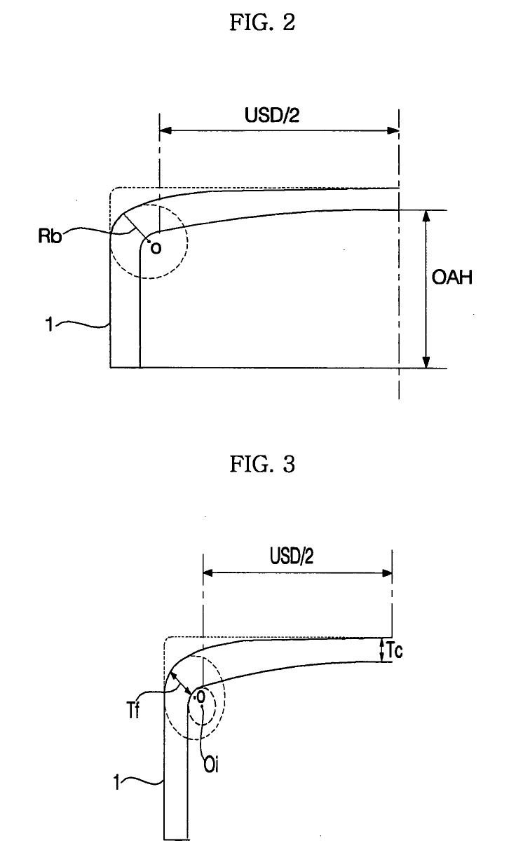

FIG. 2 is a sectional view of a panel included in a cathode ray tube according to the present invention, illustrating a radius of outer surface curvature at a blend region of the panel. FIG. 3 is a sectional view of the panel included in the cathode ray tube according to the present invention, illustrating the thickness of the panel.

As shown in FIG. 2, the panel, which is designated by reference numeral 1, has outer and inner surfaces respectively having predetermined curvatures. In FIG. 2, “USD” represents the diagonal length of an effective screen of the panel 1, and “OAH” represents the vertical length from the center of the inner surface of the panel 1 to an edge of a seal surface of the panel 1, where the panel 1 is joined with a funnel.

In particular, a blend region is formed at a portion of the panel 1 arranged outside the effective screen in accordance with the present invention. The blend region has a radius of outer surface curvature, Rb. In FIG. 2, “O” represents the center of a circle defined by the outer surface curvature of the blend region.

In accordance with a first embodiment of the present invention, the panel 1 has a blend region formed at a portion of the panel 1 outside the effective screen of the panel 1 to have an outer surface curvature radius Rb satisfying a condition “20≦Rb≦60 (nm)”.

When the outer surface curvature radius Rb of the blend region has a smaller value, it is possible to more easily adjust the thickness of corner portions of the panel 1.

However, when the outer surface curvature radius Rb of the blend region is less than 20 mm, it is impossible to achieve a reduction in manufacturing costs through a reduction in the weight of the panel 1 according to the formation of the outer surface curvature in the panel 1. In this case, there is also a problem in that the corner portions of the panel 1 have an increased thickness, thereby causing an increase in the damage rate of the panel 1.

On the other hand, when the outer surface curvature radius Rb of the blend region is more than 60 mm, a gap may be formed between the panel 1 and the cabinet, which are coupled to each other. In this case, accordingly, it is necessary to manufacture a new mold for molding a cabinet having a shape conforming to the panel 1, so that additional expenses are needed.

Thus, it is preferred that the outer surface curvature radius Rb of the blend region range from 20 mm to 60 mm.

Where outer surface curvature radius Rb of the blend region is within the above-described range, the panel 1 has weight and cost reduction effects, as described in TABLE 1.

TABLE 1

| Outer Surface | Weight | Cost |
|---|---|---|
| Curvature Radius (mm) | Reduction | Reduction |
| 10.5 | — | — |
| 26.0 | 0.15 Kg | $0.12 |
| 36.0 | 0.25 Kg | $0.22 |
| 46.0 | 0.40 Kg | $0.37 |

Results of TABLE 1 are associated with 29-inch panels respectively having different outer surface curvature radii. Referring to TABLE 1, it can be seen that, when the outer surface curvature radius of the blend region in the panel 1 increases, the weight reduction and cost reduction of the panel 1 are increased.

This is because the corner portions of the panel 1 are flatter when the outer surface curvature radius of the blend region in the panel 1 increases.

When the outer surface curvature radius Rb of the blend region is within a range of 26 to 46 mm, the panel 1 exhibits a weight reduction of 0.15 to 0.40 Kg, and thus, a manufacturing cost reduction of $0.12 to $0.37, as described in TABLE 1.

Meanwhile, in addition to the circle defined by the outer surface curvature of the blend region formed at the portion of the panel 1 arranged outside the effective screen, there is a circle defined by an inner surface curvature of the blend region, as shown in FIG. 3. In FIG. 3, “Oi” represents the center of the circle defined by the inner surface curvature of the blend region.

In FIG. 3, “Tf” represents the thickness of the thickest portion in the blend region. The maximum thickness Tf of the blend region corresponds to the thickness of the panel 1 measured along a line extending through the center Oi of the circle defined by the inner surface curvature of the blend region in a normal-line direction of the outer surface curvature of the blend region.

In accordance with a second embodiment of the present invention, the panel 1 has a blend region formed at a portion of the panel 1 outside the effective screen of the panel 1, and satisfies a condition

$$“ 1.5 \leq \frac{Tf}{Tc} 2.0 ” ,$$

where “Tf” represents the thickness of the thickest portion in the blend region, and “Tc” represents the thickness of a central portion of the panel 1.

When the ratio of the maximum thickness Tf of the blend region to the thickness Tc of the central portion of the panel 1 is within a range of 1.5 to 2.0, it is possible to reduce the thickness of the corner portions of the panel 1, and thus, to reduce the weight of the panel 1. Also, it is possible to reduce the thermal expansion rate difference between the inner and outer surfaces of the panel 1, and thus, to reduce damage of the panel 1 when the panel 1 is processed in a furnace.

When the above-described thickness ratio of the panel 1 is outside the range of 1.5 to 2.0, it is impossible to achieve a reduction in manufacturing costs through a reduction in the weight of the panel 1. Otherwise, a gap may be formed between the panel 1 and the cabinet, which are coupled to each other.

In accordance with a third embodiment of the present invention, the panel 1 has a blend region formed at a portion of the panel 1 outside the effective screen of the panel 1 to have an outer surface curvature having a center arranged outside the panel 1.

When the panel 1 is substantially vertically bent at corner portions thereof to form a skirt, as in conventional cases, the outer surface curvature of the panel 1 at the corner portions has a very small radius, so that the center of the outer surface curvature is arranged within the panel 1.

On the contrary, in accordance with the present invention, the blend region formed at the portion of the panel 1 outside the effective screen of the panel 1 has a large outer surface curvature radius to reduce the weight of the panel 1. When the outer surface curvature radius of the blend region is large such that the center of the outer surface curvature is arranged outside the panel 1, it is possible to more effectively reduce the weight of the panel 1.

Meanwhile, it is desirable to achieve the weight reduction of the panel 1 without causing a degradation in the apparent flatness perceived by the viewer when the viewer views the screen of the panel, by optimizing the outer surface curvature of the panel 1, in addition to the provision of the blend region.

It is also desirable to reduce the length of the skirt of the panel 1, thereby reducing the overall length of the panel, and thus, reducing the weight of the panel 1.

In this regard, it is preferred that the panel 1 of the cathode ray tube according to the present invention satisfy a condition

$$“ 0.18 \leq \frac{OAH}{\frac{1}{2} USD} \leq 0.29 ” ,$$

where “USD” represents the diagonal length of an effective screen of the panel 1, and “OAH” represents the vertical length from the center of the inner surface of the panel 1 to a seal edge of the skirt of the panel 1.

When the value of

$$\frac{OAH}{\frac{1}{2} USD}$$

is less than 0.18, wide-angle deflection occurs, thereby causing an increase in power consumption and a degradation in picture quality. On the other hand, when the value of

$$\frac{OAH}{\frac{1}{2} USD}$$

is more than 0.29, the effect of cost reduction through a reduction in the weight of the panel 1 in the cathode ray tube according to the present invention, improved over conventional cathode ray tubes, is insignificant. Therefore, it is preferred that the value of

$$\frac{OAH}{\frac{1}{2} USD}$$

be within a range from 0.18 to 0.29.

TABLE 2

| Size (in.) | OAH/(USD/2) | Weight Reduction | Cost Reduction |
|---|---|---|---|
| 25 | 0.18 | 0.26 Kg | $0.23 |
| | 0.29 | 2.57 Kg | $2.54 |
| 28 | 0.18 | 0.90 Kg | $0.86 |
| | 0.29 | 4.16 Kg | $4.10 |
| 29 | 0.18 | 1.13 Kg | $1.10 |
| | 0.29 | 4.39 Kg | $4.30 |
| 32 | 0.18 | 0.64 Kg | $0.61 |
| | 0.29 | 6.28 Kg | $6.20 |

Referring to TABLE 2, it can be seen that, where the panel 1 of the cathode ray tube has a size of 25 to 32 in. and satisfies the above-described condition, the panel 1 exhibits a weight reduction of 0.26 to 6.28 Kg and a cost reduction of $0.23 to $6.20.

In particular, the 29-inch cathode ray tube exhibits maximal effects in that it exhibits a weight reduction of 1.13 to 4.39 Kg, and thus, a cost reduction of $1.10 to $4.30.

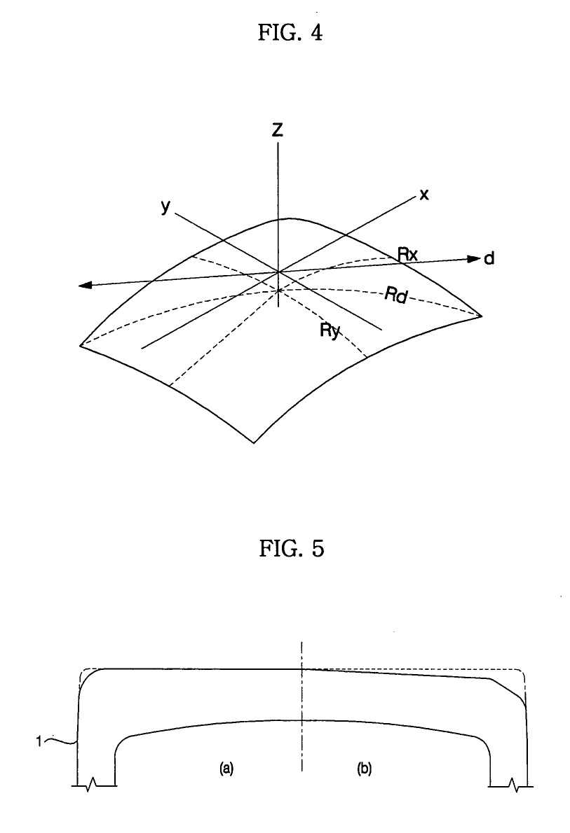

FIG. 4 is a schematic view illustrating the outer surface curvature of the panel in the cathode ray tube according to the present invention. In FIG. 4, the longer axis, shorter axis, and diagonal axis of the panel 1 may be defined as an x-axis, a y-axis and a d-axis, respectively. In FIG. 4, the radius of the outer surface curvature of the panel 1 along the longer axis represented by “Rx”, the radius of the outer surface curvature of the panel 1 along the shorter axis is represented by “Ry”, and the radius of the outer surface curvature of the panel 1 along the diagonal axis is represented by “Rd”.

In FIG. 4, “z-axis” represents the central axis of the panel.

When the panel 1 of the cathode ray tube according to the present invention has a predetermined outer surface curvature, it is possible to reduce the weight of the panel 1 without causing a degradation in the apparent flatness perceived by the viewer when the viewer views the screen of the panel 1.

It is preferred that the outer surface curvature radii Rx, Ry and Rd of the panel 1 along respective axes of the panel 1 satisfy a condition “5,000 mm≦Rx, Ry, Rd≦30,000 mm”.

In particular, it is more preferred that at least one of the outer surface curvature radii Rx, Ry, and Rd is different from the remaining ones of the outer surface curvature radii Rx, Ry, and Rd so that the panel 1 has a complex outer surface curvature.

When each outer surface curvature radius of the panel 1 is less than 5,000 mm, the panel 1 is excessively convex, thereby causing a degradation in apparent flatness. In this case, severe image distortion occurs, thereby causing a problem in reproducing an image. Furthermore, the outer surface of the panel 1 serves as a mirror, thereby reflecting external light toward the viewer at diverse angles. In this case, accordingly, a degradation in picture quality occurs. Furthermore, the fatigue of the viewer's eyes increases.

In this cathode ray tube, there may be a jointing problem in that a gap is present between the panel 1 and the cabinet surrounding the panel 1. For this reason, it is necessary to use new molds, thereby causing an increase in manufacturing costs.

On the other hand, when each outer surface curvature radius of the panel 1 is more than 30,000 mm, it is impossible to sufficiently reduce the weight of the panel 1, so that an insufficient manufacturing cost reduction is obtained.

Meanwhile, in accordance with the present invention, the panel 1 may also be configured such that the outer surface curvature radii Rx, Ry and Rd of the panel 1 along respective axes satisfy a condition

$$“ 0.5 \leq \frac{Rx + Ry}{2 \times Rd} \leq 0.9 ” ,$$

where the radius Rx is the radius of the outer surface curvature of the panel 1 along the longer axis, the radius Ry is the radius of the outer surface curvature of the panel 1 along the shorter axis, and the radius Rd is the radius of the outer surface curvature of the panel 1 along the diagonal axis.

When the value of

$$\frac{Rx + Ry}{2 \times Rd}$$

in the above-described condition given to the outer surface curvature of the panel 1 is outside the range of 0.5 to 0.9, there is a degradation in apparent flatness. Otherwise, the outer surface of the panel 1 has an insufficient curvature, so that it is impossible to achieve a sufficient weight reduction of the panel 1.

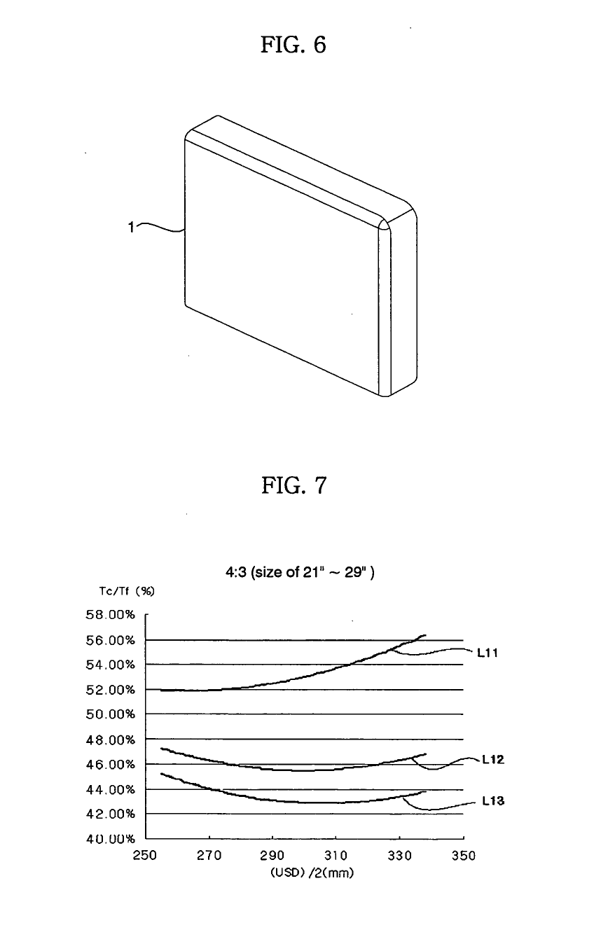

FIG. 5 is a sectional view illustrating the shape of the panel in the cathode ray tube according to the present invention, as compared to the shape of a conventional panel. FIG. 6 is a perspective view illustrating the shape of the panel in the cathode ray tube according to the present invention.

As shown in a portion “b” of FIG. 5, in the cathode ray tube according to the present invention, the blend region, which is formed outside the effective screen of the panel, is flattened to reduce the weight of the panel 1.

In accordance with the present invention, the outer surface of the panel 1 has a predetermined curvature to reduce the weight of the panel 1 without causing a degradation in the apparent flatness perceived by the viewer when the viewer views the screen of the panel 1.

Referring to FIG. 6, which is a perspective view of the panel 1 having the above-described structure, it can be seen that each corner of the panel 1 is cut to have a flat surface.

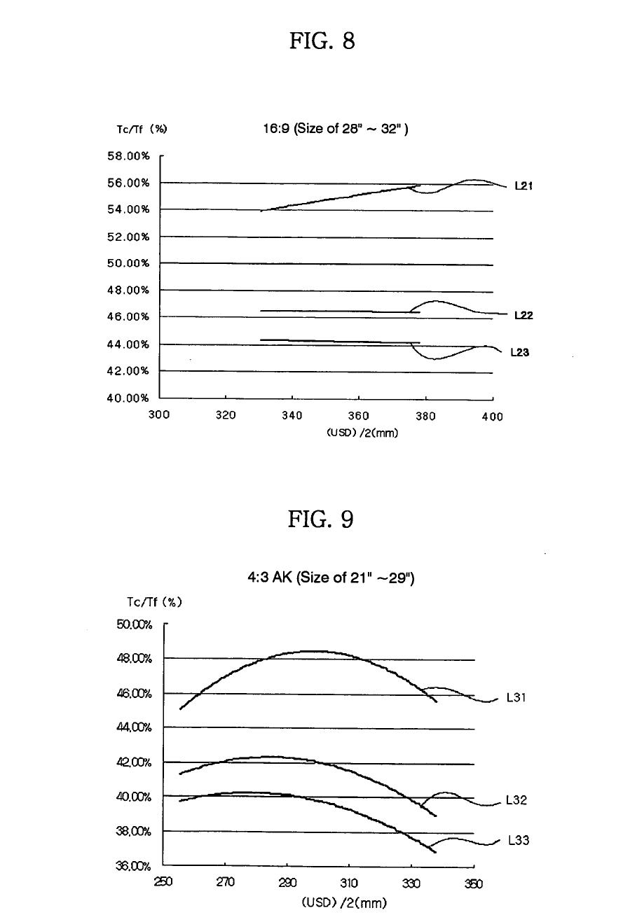

FIG. 7 is a graph depicting the thickness characteristics of the panel in the cathode ray tube according to the present invention where the panel has an aspect ratio of 4:3. FIG. 8 is a graph depicting the thickness characteristics of the panel in the cathode ray tube according to the present invention where the panel has an aspect ratio of 16:9. FIG. 9 is a graph depicting the thickness characteristics of the panel in the cathode ray tube according to the present invention where the panel has an aspect ratio of 4:3, and a shadow mask made of an aluminum killed (AK) material is used.

As shown in FIG. 7, the panel 1 exhibits a Tc/Tf value higher than those of conventional cases when the panel 1 has a size ranging from 21 inches to 29 inches, an aspect ratio of 4:3, and an outer surface curvature radius ranging from 5,000 mm to 30,000 mm.
y=7.6e⁻⁰⁶x²−0.004x+1.0459 [Expression 1]

In particular, where the panel 1 has an outer surface curvature radius of 10,000 mm (L11), the panel 1 exhibits a Tc/Tf value higher than that of a conventional case (L13) by 6 to 12%, as shown in FIG. 7. The graph depicting a variation in Tc/Tf value depending on a variation in effective screen area can be numerically expressed by Expression 1. In Expression 1, “x” represents USD/2, and “y” represents “Tc/Tf”.

On the other hand, where the panel 1 has an outer surface curvature radius of 30,000 mm (L12), the panel 1 exhibits a Tc/Tf value higher than that of the conventional case (L13) by 2 to 3%, as shown in FIG. 7. The Tc/Tf value of the panel 1 varying depending on a variation in USD/2 satisfies the following Expression 2:
y=9.03e⁻⁰⁶x²−0.0054x+1.2621 [Expression 2]

Referring to FIG. 8, it can be seen that, where the panel 1 has a size ranging from 28 inches to 32 inches, the panel 1 exhibits a variation in Tc/Tf value depending on a variation in aspect ratio, for example, exhibits different Tc/Tf values between the case having an aspect ratio of 16:9 and the case having an aspect ratio of 4:3. The graph of FIG. 8 depicts a Tc/Tf value obtained by taking a natural log of the USD/2 value indicated on the x-axis of the graph.
y=0.1421n(x)−0.2844 [Expression 3]

Where the panel 1 has an outer surface curvature radius of 10,000 mm (L21), the panel 1 exhibits a Tc/Tf value higher than that of the conventional case (L23) by 10 to 12%. The Tc/Tf value of the panel 1 varying depending on a variation in effective screen area satisfies the above-described Expression 3.
y=−0.00461n(x)+0.4915 [Expression 4]

Also, where the panel 1 has an outer surface curvature radius of 30,000 mm (L22), the Tc/Tf value variation depending on the effective screen area variation can be numerically expressed by the above-described Expression 4. Referring to Expression 4, it can be seen that the panel 1 exhibits a Tc/Tf value higher than that of the conventional case (L23) by 2%.

In particular, where the cathode ray tube includes a shadow mask made of an AK material, the panel 1 exhibits a Tc/Tf value higher than that of the conventional case (L33) by 5 to 8% in the case of having an aspect ratio of 4:3 and an outer surface curvature radius of 10,000 mm (L31) and by about 2% in the case of having an aspect ratio of 4:3 and an outer surface curvature radius of 30,000 mm (L32), as shown in FIG. 9.
y=−1.84e⁻⁰⁵x²+0.011x−1.1593 [Expression 5]
y=−1.18e⁻⁰⁵x²+0.0067x−0.5278 [Expression 6]

The Tc/Tf values depending on effective screen area in association with the above-described outer surface curvature radii can be numerically expressed by the above-described Expressions 5 and 6, respectively.

As shown in FIGS. 7 to 9, the cathode ray tube according to the present invention has a Tc/Tf value higher than that of the conventional case, so that it is possible to reduce the amount of panel glass at the corner portions of the panel 1, thereby reducing the weight of the panel 1, and thus, reducing the manufacturing costs.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

As apparent from the above description, the cathode ray tube according to the present invention includes a panel having a blend region formed outside an effective screen of the panel to have a radius of outer surface curvature within a predetermined range. Accordingly, it is possible to reduce the weight of the panel, and thus, to reduce the manufacturing costs. It is also possible to reduce damage of the panel when the panel is processed in a furnace, and thus, to achieve an enhancement in productivity.

In accordance with the present invention, the panel has an optimal outer surface curvature to reduce the weight of the panel without causing a degradation in the apparent flatness perceived by the viewer when the viewer views the screen of the panel, thereby being capable of achieving a reduction in manufacturing costs.

What is claimed is:

1. A cathode ray tube comprising a panel having a predetermined curvature, a funnel coupled to a rear end of the panel, an electron gun adapted to emit an electron beam, a deflection yoke adapted to vertically and horizontally deflect the electron beam, and a shadow mask provided with a plurality of slots to perform a color selecting function for the electron beam, wherein:
the panel is formed with a blend region outside an effective screen of the panel; and
the blend region has an outer surface curvature having a radius satisfying the following condition:
20≦Rb≦60 (mm)
where, “Rb” represents the outer surface curvature radius.

2. The cathode ray tube according to claim 1, wherein the panel satisfies the following condition:
$$1.5 \leq \frac{Tf}{Tc} 2.0$$
where, “Tf” represents a thickness of a thickest portion in the blend region, and “Tc” represents a thickness of a central portion of the panel.

3. The cathode ray tube according to claim 2, wherein the outer surface curvature of the blend region has a center arranged outside the panel.

4. The cathode ray tube according to claim 1, wherein the panel satisfies the following condition:
$$0.18 \leq \frac{OAH}{\frac{1}{2} USD} \leq 0.29$$
where, “USD” represents a diagonal length of the effective screen of the panel, and “OAH” represents a vertical length from a center of an inner surface of the panel to a seal edge of the panel.

5. The cathode ray tube according to claim 1, wherein the panel has an outer surface curvature satisfying the following condition:
5,000 (mm)≦Rx, Ry, Rd≦30,000 (mm)
where, “Rx” represents a radius of outer surface curvature of the panel along a longer axis of the panel, “Ry” represents a radius of outer surface curvature of the panel along a shorter axis of the panel, and “Rd” represents a radius of outer surface curvature of the panel along a diagonal axis of the panel.

6. The cathode ray tube according to claim 1, wherein the panel has an outer surface curvature satisfying the following condition:
$$0.5 \leq \frac{Rx + Ry}{2 \times Rd} \leq 0.9$$
where, “Rx” represents a radius of outer surface curvature of the panel along a longer axis of the panel, “Ry” represents a radius of outer surface curvature of the panel along a shorter axis of the panel, and “Rd” represents a radius of outer surface curvature of the panel along a diagonal axis of the panel.

7. The cathode ray tube according to claim 1, wherein the effective screen of the panel has an aspect ratio of 16:9.

8. The cathode ray tube according to claim 1, wherein the effective screen of the panel has an aspect ratio of 4:3.

9. A cathode ray tube comprising a panel having a predetermined curvature, a funnel coupled to a rear end of the panel, an electron gun adapted to emit an electron beam, a deflection yoke adapted to vertically and horizontally deflect the electron beam, and a shadow mask provided with a plurality of slots to perform a color selecting function for the electron beam, wherein:
the panel is formed with a blend region outside an effective screen of the panel; and
the panel satisfies the following condition:
$$1.5 \leq \frac{Tf}{Tc} 2.0$$
where, “Tf” represents a thickness of a thickest portion in the blend region, and “Tc” represents a thickness of a central portion of the panel.

10. The cathode ray tube according to claim 9, wherein the outer surface curvature of the blend region has a center arranged outside the panel.

11. The cathode ray tube according to claim 9, wherein the panel satisfies the following condition:
$$0.18 \leq \frac{OAH}{\frac{1}{2} USD} \leq 0.29$$
where, “USD” represents a diagonal length of the effective screen of the panel, and “OAH” represents a vertical length from a center of an inner surface of the panel to a seal edge of the panel.

12. The cathode ray tube according to claim 9, wherein the panel has an outer surface curvature satisfying the following condition:
5,000 (mm)≦Rx, Ry, Rd≦30,000 (mm)
where, “Rx” represents a radius of outer surface curvature of the panel along a longer axis of the panel, “Ry” represents a radius of outer surface curvature of the panel along a shorter axis of the panel, and “Rd” represents a radius of outer surface curvature of the panel along a diagonal axis of the panel.

13. The cathode ray tube according to claim 9, wherein the panel has an outer surface curvature satisfying the following condition:
$$0.5 \leq \frac{Rx + Ry}{2 \times Rd} \leq 0.9$$
where, “Rx” represents a radius of outer surface curvature of the panel along a longer axis of the panel, “Ry” represents a radius of outer surface curvature of the panel along a shorter axis of the panel, and “Rd” represents a radius of outer surface curvature of the panel along a diagonal axis of the panel.

14. The cathode ray tube according to claim 9, wherein the effective screen of the panel has an aspect ratio of 16:9.

15. The cathode ray tube according to claim 9, wherein the effective screen of the panel has an aspect ratio of 4:3.

16. A cathode ray tube comprising a panel having a predetermined curvature, a funnel coupled to a rear end of the panel, an electron gun adapted to emit an electron beam, a deflection yoke adapted to vertically and horizontally deflect the electron beam, and a shadow mask provided with a plurality of slots to perform a color selecting function for the electron beam, wherein:
the panel is formed with a blend region outside an effective screen of the panel; and
the blend region has an outer surface curvature having a center arranged outside the panel.

17. The cathode ray tube according to claim 16, wherein the outer surface curvature of the blend region has a radius satisfying the following condition:
20≦Rb≦60 (mm)
where, “Rb” represents the outer surface curvature radius.

18. The cathode ray tube according to claim 16, wherein the panel satisfies the following condition:
$$0.18 \leq \frac{OAH}{\frac{1}{2} USD} \leq 0.29$$
where, “USD” represents a diagonal length of the effective screen of the panel, and “OAH” represents a vertical length from a center of an inner surface of the panel to a seal edge of the panel.

19. The cathode ray tube according to claim 16, wherein the panel has an outer surface curvature satisfying the following condition:
5,000 (mm)≦Rx, Ry, Rd≦30,000 (mm)
where, “Rx” represents a radius of outer surface curvature of the panel along a longer axis of the panel, “Ry” represents a radius of outer surface curvature of the panel along a shorter axis of the panel, and “Rd” represents a radius of outer surface curvature of the panel along a diagonal axis of the panel.

20. The cathode ray tube according to claim 16, wherein the panel has an outer surface curvature satisfying the following condition:
$$0.5 \leq \frac{Rx + Ry}{2 \times Rd} \leq 0.9$$
where, “Rx” represents a radius of outer surface curvature of the panel along a longer axis of the panel, “Ry” represents a radius of outer surface curvature of the panel along a shorter axis of the panel, and “Rd” represents a radius of outer surface curvature of the panel along a diagonal axis of the panel.

21. The cathode ray tube according to claim 16, wherein the effective screen of the panel has an aspect ratio of 16:9.

22. The cathode ray tube according to claim 16, wherein the effective screen of the panel has an aspect ratio of 4:3.
